(19) United States
(12) Patent Application Publication
(10) Pub. No.: US 2017/0037787 A1
(43) Pub. Date: Feb. 9, 2017

(54) Control Device and Control Method for Internal Combustion Engine

(71) Applicant: TOYOTA JIDOSHA KABUSHIKI KAISHA, Toyota-shi (JP)

(72) Inventors: Satoshi WATANABE, Okazaki-shi (JP); Isao TAKAGI, Okazaki-shi (JP); Masaya SUNAGO, Toyota-shi (JP); Shoichi AKIYAMA, Toyota-shi (JP); Kenji SENDA, Okazaki-shi (JP); Norihito HANAI, Toyota-shi (JP); Hisayuki ITO, Toyota-shi (JP)

(73) Assignee: TOYOTA JIDOSHA KABUSHIKI KAISHA, Toyota-shi (JP)

(21) Appl. No.: 15/223,770

(22) Filed: Jul. 29, 2016

(30) Foreign Application Priority Data
Aug. 6, 2015 (JP) 2015-155958

(51) Int. Cl. F02D 13/02; F02D 35/02; F01L 1/344

(52) U.S. Cl. CPC F02D 13/0238; F01L 1/3442; F02D 35/027; F01L 2001/34456

(57) ABSTRACT

An engine includes a variable valve mechanism capable of holding a valve timing of an intake valve in an intermediate phase when the engine is started. An ECU calculates a degree of deposit adhesion in a combustion chamber, and calculates a deposit correction amount that is a retard correction amount for an ignition timing set in accordance with the calculated degree of the deposit adhesion. The ECU calculates a first correction amount that is a first adaptive value for the retard correction amount for the ignition timing in a reference phase of the valve timing and a second correction amount that is a second adaptive value for the retard correction amount for the ignition timing in an adaptation phase of the valve timing. The deposit correction amount is set based on the first correction amount and the second correction amount.

### INCORPORATION BY REFERENCE

The disclosure of Japanese Patent Application No. 2015-155958 filed on Aug. 6, 2015 including the specification, drawings and abstract is incorporated herein by reference in its entirety.

### BACKGROUND

1. Technical Field

The disclosure relates to a control device and a control method for an internal combustion engine.

2. Description of Related Art

A deposit derived from unburned fuel, blow-by gas, lubricating oil, or the like gradually adheres inside a combustion chamber of an internal combustion engine. When the amount of the deposit adhesion increases, knocking becomes more and more likely to occur due to, for example, a decrease in a substantial volume of the combustion chamber that leads to an increase in an in-cylinder pressure during combustion.

In an internal combustion engine that is provided with a variable valve mechanism that varies a valve timing of an intake valve, an internal exhaust gas recirculation (EGR) amount, an actual compression ratio, a flow of an air flow in a cylinder, or the like changes as a result of a change in the valve timing. Accordingly, the ease of the occurrence of the knocking that is attributable to the deposit adhesion changes, even at the same deposit adhesion amount, when the valve timing of the intake valve varies.

In the internal combustion engine, the ease of the occurrence of the knocking changes depending on the amount of the deposit adhering inside the combustion chamber and the valve timing of the intake valve as described above. Accordingly, a retard correction amount for an ignition timing is set in view of the deposit adhesion amount and the valve timing.

In a device disclosed in Japanese Patent Application Publication No. 2005-147112 (JP 2005-147112 A), a maximum ignition timing retard amount (DLAKNOK), which is an ignition timing correction amount required in a state where the deposit adhesion amount is at its maximum that is assumed, is obtained in advance. Then, a retard correction amount for the ignition timing commensurate with the current deposit adhesion amount and valve timing is calculated by this maximum ignition timing retard amount being multiplied by a ratio learning value (rgknk) indicating a degree of the deposition adhesion and a VVT advance correction coefficient (kavvt) indicating the amount of an effect of the valve timing on an ignition timing correction in accordance with the deposit adhesion.

In a device disclosed in Japanese Patent Application Publication No. 2010-248983 (JP 2010-248983 A), an ignition timing correction amount taking the amount of an effect of the valve timing on the knocking into account is calculated as follows. That is, an ignition timing correction amount that is required when a valve overlap amount is an adaptive value optimal at a current engine rotation speed and a current engine load (such as a target valve overlap amount at the current engine rotation speed and engine load) is obtained in advance, and a map is prepared in which the obtained correction amount is a base ignition correction amount. Then, the ignition timing correction amount in accordance with the actual valve overlap amount is obtained by the calculation of a value obtained by the base ignition correction amount at the current engine rotation speed and engine load being multiplied by a ratio between the actual valve overlap amount and the target valve overlap amount. In other words, an optimum valve timing in accordance with an engine operation state is regarded as an adaptation phase, and an ignition timing correction amount corresponding to this adaptation phase is obtained in advance. Then, an ignition timing correction amount in accordance with the present valve timing is obtained by correcting the ignition timing correction amount in accordance with a ratio between a value associated with the adaptation phase of the valve timing (such as the target valve overlap amount) and a value associated with the actual valve timing (actual valve overlap amount).

### SUMMARY

In a case where a phase in which the amount of an effect of the valve timing on the retard correction amount for the ignition timing is almost negligible (such as a phase in which the internal EGR amount is extremely small) is regarded as a reference phase, the retard correction amount for the ignition timing in this reference phase is set to, for example, “0”. In this case, the retard correction amount for the ignition timing, at a time when the actual valve timing has become a phase between the reference phase and the adaptation phase, is obtained by the retard correction amount for the ignition timing corresponding to the adaptation phase being multiplied by the VVT advance correction coefficient (kavvt) and the ratio learning value (rgknk). In this aspect of the calculation of the retard correction amount corresponding to the actual valve timing, however, the retard correction amount in the reference phase becomes “0” even though the reference phase also requires a certain degree of retard correction amount for suppression of the occurrence of the knocking attributable to the deposit adhesion. Accordingly, when the actual valve timing has become a phase in the vicinity of the reference phase, an error between the calculated retard correction amount and the retard correction amount that is actually required increases in some cases.

In some internal combustion engines, a variable valve mechanism is disposed that is configured to hold the valve timing of the intake valve in an intermediate phase, which is set in the middle between the most retarded phase and the most advanced phase, when the internal combustion engine is started. Compared to a variable valve mechanism that is configured to hold the valve timing of the intake valve in either the most retarded phase or the most advanced phase during the start of the internal combustion engine, this variable valve mechanism that is configured to hold the valve timing in the intermediate phase achieves more significantly changing the valve timing of the intake valve from an intake bottom dead center to a retarded phase side. Thus, the variable valve mechanism that is configured to hold the valve timing in the intermediate phase is suitable for carrying out, for example, an Atkinson cycle effective for thermal efficiency improvement.

In an internal combustion engine that has a variable valve mechanism which is not provided with a mechanism for holding the valve timing of the intake valve in the intermediate phase during the start of the internal combustion engine, the actual valve timing becomes a valve timing in the vicinity of the adaptation phase set for the retard correction amount to be obtained in many cases, and thus the chance of the use of a valve timing in the vicinity of the reference phase is slim. Accordingly, despite the calculation of the retard correction amount in accordance with the actual valve timing in the above-described aspect, an error between the calculated retard correction amount and the actually required retard correction amount is kept at a relatively low level.

In contrast, in the internal combustion engine that is provided with the variable valve mechanism which is configured to hold the valve timing of the intake valve in the intermediate phase during the start of the internal combustion engine, the actual valve timing is used not only in the vicinity of the adaptation phase but also across a wide range between an advance side phase and a retard side phase. Accordingly, the frequency of passage through the reference phase in which the retard correction amount error is large is high when the valve timing is changed. In addition, in the variable valve mechanism that is configured to hold the valve timing of the intake valve in the intermediate phase, the actual valve timing is significantly changed to the retarded phase side in some cases as described above unlike in the variable valve mechanism that is not capable of holding the valve timing of the intake valve in the intermediate phase. In many cases, the adaptation phase is set as a phase on a further advanced side than the reference phase. Accordingly, when the actual valve timing is significantly changed to the retarded phase side, the actual valve timing is significantly separated from the adaptation phase, and the retard correction amount error is likely to increase even in this case.

As described above, in the internal combustion engine that is provided with the variable valve mechanism which is configured to hold the valve timing of the intake valve in the intermediate phase, the error between the calculated retard correction amount and the actually required retard correction amount increases in some cases, and calculation of the retard correction amount for the suppression of the occurrence of the knocking attributable to the deposit adhesion may not be accurate.

The disclosure provides a control device and a control method for an internal combustion engine allowing occurrence of knocking attributable to deposit adhesion to be suppressed in an appropriate manner.

An example aspect of the disclosure provides a control device for an internal combustion engine. The internal combustion engine includes an intake valve, a combustion chamber, and a variable valve mechanism. The variable valve mechanism is configured to change a valve timing of the intake valve, and is configured to hold the valve timing in an intermediate phase when the internal combustion engine is started. The intermediate phase is a phase set in a middle between a most retarded phase and a most advanced phase of the valve timing of the intake valve. The control device includes an electronic control unit. The electronic control unit is configured to: calculate a degree of deposit adhesion in the combustion chamber; calculate a deposit correction amount, the deposit correction amount being a retard correction amount for an ignition timing set in accordance with the degree of the deposit adhesion; calculate, as a reference correction amount, a first adaptive value for the retard correction amount for the ignition timing with which occurrence of knocking is suppressed when the amount of the deposit adhesion is equal to or more than a predetermined amount and a phase of a present valve timing is a reference phase, the reference phase being a phase of the valve timing at which an internal exhaust gas recirculation amount in the combustion chamber is minimized; calculate a first correction amount by correcting the reference correction amount in accordance with the degree of the deposit adhesion; calculate, as an adaptive correction amount, a second adaptive value for the retard correction amount for the ignition timing with which the occurrence of the knocking is suppressed when the amount of the deposit adhesion is equal to or more than the predetermined amount and the phase of the present valve timing is an adaptation phase, the adaptation phase being a phase of the valve timing optimal in accordance with an engine operation state; calculate a relative correction amount by subtracting the reference correction amount from the adaptive correction amount; calculate a correction ratio indicating a degree of an effect of the present valve timing on an ignition timing correction in accordance with the degree of the deposit adhesion; calculate a second correction amount by correcting the relative correction amount in accordance with the degree of the deposit adhesion and the correction ratio; and set a sum of the first correction amount and the second correction amount as the deposit correction amount.

According to the configuration described above, an optimum value for the retard correction amount for the ignition timing at a time when the valve timing has little effect is calculated when the valve timing has become the reference phase at the retard correction amount for the ignition timing in accordance with the present degree of the deposit adhesion by the first correction amount being calculated, that is, during the calculation of the retard correction amount for the ignition timing in accordance with the degree of the deposit adhesion by the valve timing at which the internal EGR amount in the combustion chamber is minimized being set.

In addition, the relative correction amount is the value obtained by subtracting the reference correction amount from the adaptive correction amount and is a value obtained by subtracting the adaptive value for the retard correction amount in the reference phase from the adaptive value for the retard correction amount in the adaptation phase, and thus this relative correction amount is also an adaptive value for the retard correction amount in the adaptation phase. The second correction amount obtained by the relative correction amount, which is this adaptive value, being corrected in accordance with the correction ratio and the degree of the deposit adhesion is a value obtained by the use of an adaptive value and is an optimum value reflecting the amount of an effect of the present valve timing among the retard correction amounts for the ignition timing in accordance with the present valve timing and the present degree of the deposition adhesion.

The sum of the first correction amount obtained by the use of the reference correction amount and the second correction amount obtained by the use of the relative correction amount and the correction ratio is set as the deposit correction amount. Accordingly, this deposit correction amount is a value obtained by the use of the adaptive value in the reference phase and the adaptive value in the adaptation phase and a value obtained when a retard correction amount present on a line connecting the optimum value of the retard correction amount in the reference phase and the optimum value of the retard correction amount in the adaptation phase to each other is interpolated. Accordingly, the deposit correction amount is a value that is close to the retard correction amount which is actually required for the suppression of the occurrence of the knocking.

As described above, according to the configuration described above, the deposit correction amount that is the retard correction amount for the ignition timing in accordance with the present degree of the deposition adhesion in the combustion chamber and the present intake valve timing can be accurately calculated. Accordingly, the occurrence of the knocking that is attributable to the deposit adhesion can be appropriately suppressed.

In the control device, the electronic control unit may be configured to calculate a base correction amount and a timing correction amount. The electronic control unit may be configured to calculate in accordance with a degree of an effect of the valve timing on the knocking of the internal combustion engine. The base correction amount may be a correction amount of an ignition timing when the valve timing is the adaptation phase. The electronic control unit may be configured to calculate the timing correction amount in accordance with the degree of the effect of the valve timing on the knocking. The timing correction amount may be a correction amount of the ignition timing and the timing correction amount is set in accordance with the present valve timing. The electronic control unit may be configured to set a ratio of the timing correction amount to the base correction amount as the correction ratio.

In the control device, the electronic control unit may be configured to set the correction ratio to 0 when the base correction amount is equal to or less than a predetermined threshold. According to the configuration described above, occurrence of an inconvenience in the form of a significant change in the correction ratio despite a slight valve timing change is suppressed in a case where the base correction amount is a relatively small value, and the deposit correction amount is stabilized.

In the control device, the variable valve mechanism may be an electric mechanism driven by an electric motor. The variable valve mechanism may be a hydraulic mechanism. The variable valve mechanism may include a lock pin fixing the valve timing in the intermediate phase.

Another example aspect of the disclosure provides a control method for an internal combustion engine. The internal combustion engine includes an intake valve, a combustion chamber, and a variable valve mechanism. The variable valve mechanism is configured to change a valve timing of the intake valve. The variable valve mechanism is configured to hold the valve timing in an intermediate phase when the internal combustion engine is started. The intermediate phase is a phase set in a middle between a most retarded phase and a most advanced phase of the valve timing of the intake valve. The control method includes: calculating, by the electronic control unit, a degree of deposit adhesion in the combustion chamber; calculating, by the electronic control unit, a deposit correction amount, the deposit correction amount being a retard correction amount for an ignition timing set in accordance with the degree of the deposit adhesion; calculating, by the electronic control unit, as a reference correction amount, a first adaptive value for the retard correction amount for the ignition timing with which occurrence of knocking is suppressed when the amount of the deposit adhesion is equal to or more than a predetermined amount and a phase of the present valve timing is a reference phase, the reference phase being a phase of the valve timing at which an internal exhaust gas recirculation amount in the combustion chamber is minimized; calculating, by the electronic control unit, a first correction amount by correcting the reference correction amount in accordance with the degree of the deposit adhesion; calculating, by the electronic control unit, as an adaptive correction amount, a second adaptive value for the retard correction amount for the ignition timing with which the occurrence of the knocking is suppressed when the amount of the deposit adhesion is equal to or more than the predetermined amount and the phase of a present valve timing is an adaptation phase, the adaptation phase being a phase of the valve timing optimal in accordance with an engine operation state; calculating, by the electronic control unit, a relative correction amount by subtracting the reference correction amount from the adaptive correction amount; calculating, by the electronic control unit, a correction ratio indicating a degree of an effect of the present valve timing on an ignition timing correction in accordance with the degree of the deposit adhesion; calculating, by the electronic control unit, a second correction amount by correcting the relative correction amount in accordance with the degree of the deposit adhesion and the correction ratio; and setting, by the electronic control unit, a sum of the first correction amount and the second correction amount as the deposit correction amount.

### BRIEF DESCRIPTION OF THE DRAWINGS

Features, advantages, and technical and industrial significance of exemplary embodiments will be described below with reference to the accompanying drawings, in which like numerals denote like elements, and wherein:

FIG. 1 is a schematic diagram illustrating a structure of an internal combustion engine with regard to an embodiment of a control device for an internal combustion engine;

FIG. 2 is a graph illustrating a change in a valve timing of an intake valve according to the embodiment;

FIG. 3 is a schematic diagram illustrating how an ignition timing is set according to the embodiment;

FIG. 4 is a graph illustrating a change in a timing correction amount associated with a change in an actual valve timing according to the embodiment;

FIG. 5 is a graph illustrating how a deposit correction amount is calculated according to the embodiment; and

FIG. 6 is a schematic diagram illustrating a structure of a variable valve mechanism according to a modification example of the embodiment.

### DETAILED DESCRIPTION OF EMBODIMENTS

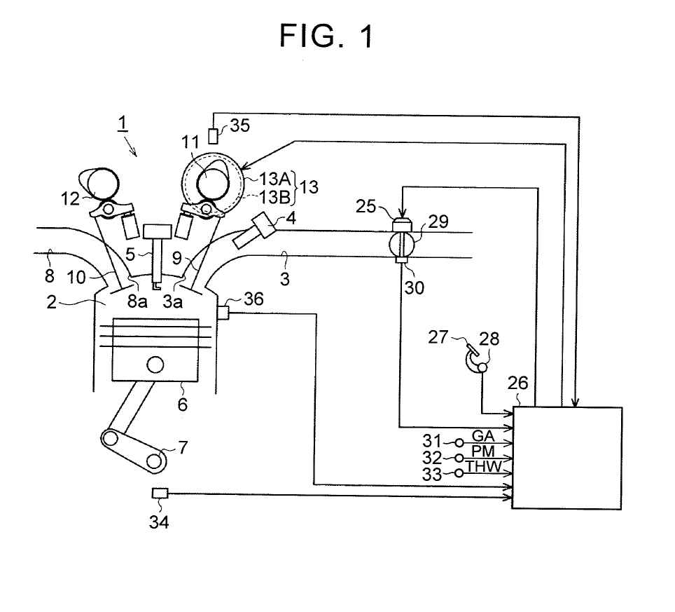

Hereinafter, a specific embodiment of a control device for an internal combustion engine will be described with reference to FIGS. 1 to 5. In an internal combustion engine 1, an intake air is suctioned into a combustion chamber 2 through an intake passage 3 and an intake port 3a. In the internal combustion engine 1, fuel is injected from a fuel injection valve 4 and supplied to the combustion chamber 2 as illustrated in FIG. 1. Once ignition by an ignition plug 5 is performed on an air-fuel mixture, the air-fuel mixture is burned, a piston 6 reciprocates, and a crankshaft 7 rotates. The crankshaft 7 is an output shaft of the internal combustion engine 1. After the combustion, the air-fuel mixture is discharged from the combustion chamber 2 to an exhaust passage 8 as exhaust gas.

A throttle valve 29 is disposed in the intake passage 3 of the internal combustion engine 1. The throttle valve 29 is configured to adjust the amount of the intake air. An electric motor 25 is configured to adjust an opening degree of the throttle valve 29. An intake valve 9 is disposed in the intake port 3a. The intake port 3a leads to the intake passage 3. An exhaust valve 10 is disposed in an exhaust port 8a. The exhaust port 8a leads to the exhaust passage 8. The intake valve 9 and the exhaust valve 10 are operated to be opened or closed as a result of rotation of an intake camshaft 11 and an exhaust camshaft 12 to which the rotation of the crankshaft 7 is transmitted.

A variable valve mechanism 13 is disposed at the intake camshaft 11. The variable valve mechanism 13 is configured to change a valve timing of the intake valve 9. The variable valve mechanism 13 is provided with a phase variable mechanism 13A and an electric motor 13B. The phase variable mechanism 13A changes the valve timing of the intake valve 9 by regulating a relative rotational phase of the intake camshaft 11 with respect to the crankshaft 7. The electric motor 13B drives the phase variable mechanism 13A.

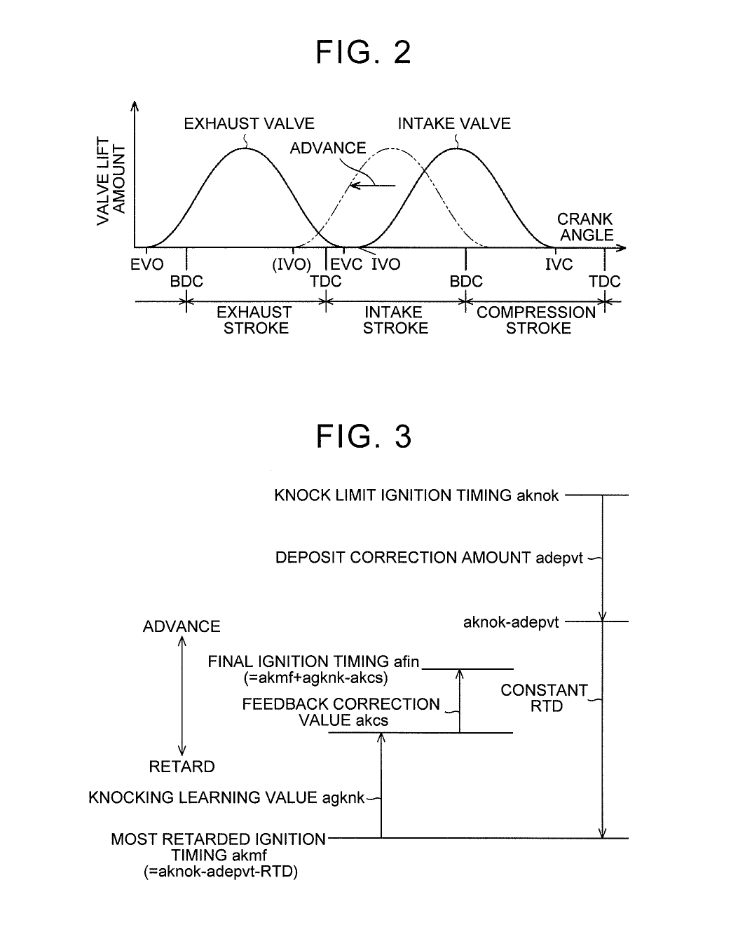

Once the variable valve mechanism 13 is put into operation through a driving control on the motor 13B, both an opening timing IVO and a closing timing IVC of the intake valve 9 are changed to an advance side or a retard side as illustrated in FIG. 2. The most retarded phase of the valve timing of the intake valve 9 is set to a phase in which the closing timing IVC of the intake valve 9 is a timing significantly separated to the retard side from a bottom dead center BDC of an intake stroke. In addition, when the valve timing of the intake valve 9 has become the most retarded phase, the opening timing IVO of the intake valve 9 is a timing later than a closing timing EVC of the exhaust valve 10, and opening periods of the intake valve 9 and the exhaust valve 10 do not overlap with each other.

The most advanced phase of the valve timing of the intake valve 9 is set to a phase in which the opening timing IVO of the intake valve 9 is a timing earlier by a predetermined amount than a top dead center TDC of the intake stroke. In addition, when the valve timing of the intake valve 9 has become the most advanced phase, the opening timing IVO of the intake valve 9 is a timing earlier than the closing timing EVC of the exhaust valve 10, and the opening periods of the intake valve 9 and the exhaust valve 10 overlap with each other.

When the internal combustion engine 1 is started, the valve timing of the intake valve 9 is held in an intermediate phase that is set in the middle between the most retarded phase and the most advanced phase. A phase that is suitable during the start of the internal combustion engine 1 and has a minimum internal exhaust gas recirculation (EGR) amount, such as a phase in which the opening timing IVO of the intake valve 9 and the closing timing EVC of the exhaust valve 10 become substantially the same timing, is set as the intermediate phase.

In the internal combustion engine 1, the Atkinson cycle is carried out by the variable valve mechanism 13 performing a late closing control on the intake valve 9, that is, a control for closing the intake valve 9 at a timing significantly retarded from an intake bottom dead center of the piston 6. In this Atkinson cycle, the closing timing of the intake valve 9 is later than the intake bottom dead center of the piston 6, and thus intake air suctioned into a cylinder is blown back to the intake port 3a in an early stage of a compression stroke. This causes a substantial initiation of the compression stroke to be delayed. As a result, a high expansion ratio is achieved without an increase in an actual compression ratio. In the Atkinson cycle that allows the expansion ratio to be raised as described above, thermal energy of the fuel is efficiently converted to kinetic energy. Accordingly, thermal efficiency of the internal combustion engine 1 is improved.

Various types of controls for the internal combustion engine 1 are performed by an electronic control unit (ECU) 26. The electronic control unit 26 is provided with a CPU, a ROM, a RAM, a backup memory, input and output ports, and the like. The CPU is configured to execute a calculation processing regarding the control of the internal combustion engine 1. A program and data that are required for the control of the internal combustion engine 1 are stored in the ROM. A calculation result of the CPU is temporarily stored in the RAM. The input and output ports are configured for a signal to be input from and output to the outside of the electronic control unit 26.

An accelerator position sensor 28, a throttle position sensor 30, an air flow meter 31, an intake pressure sensor 32, a water temperature sensor 33, a crank angle sensor 34, a cam position sensor 35, and a knock sensor 36 are connected to the input port of the electronic control unit 26. The accelerator position sensor 28 detects an operation amount of an accelerator pedal 27 (accelerator operation amount) that is operated by a driver of a vehicle.

The throttle position sensor 30 detects the opening degree of the throttle valve 29 (throttle opening degree) that is disposed in the intake passage 3. The air flow meter 31 detects the amount of the air that is suctioned into the combustion chamber 2 through the intake passage 3 (suctioned air amount GA).

The intake pressure sensor 32 detects an intake pressure PM in the intake passage 3. The water temperature sensor 33 detects a cooling water temperature THW of the internal combustion engine 1. The crank angle sensor 34 detects a crank angle of the crankshaft 7.

The cam position sensor 35 detects an actual phase of the intake valve 9, that is, an actual valve timing VTr, by outputting a signal corresponding to a rotational position of a camshaft. The knock sensor 36 detects knocking that occurs in the combustion chamber 2.

Drive circuits such as actuators driving the electric motor 25 of the throttle valve 29, the fuel injection valve 4, the ignition plug 5, and the variable valve mechanism 13 are connected to the output port of the electronic control unit 26.

The electronic control unit 26 grasps an engine operation state based on signals input from the above-described various sensors and the like and outputs command signals to the various drive circuits connected to the output port in accordance with the grasped engine operation state. In this manner, the electronic control unit 26 controls the quantity of fuel injection by the fuel injection valve 4, an ignition timing of the ignition plug 5, the valve timing of the intake valve 9, the opening degree of the throttle valve 29, and the like.

As the valve timing control, the electronic control unit 26 calculates a target valve timing VTp, which is a control target value for the valve timing of the intake valve 9, based on an engine rotation speed NE and an engine load KL. Then, the valve timing control for the intake valve 9 is performed by the driving control being performed on the motor 13B such that the actual valve timing VTr of the intake valve 9 detected by the cam position sensor 35 reaches the target valve timing VTp.

In this embodiment, the valve timing of the intake valve 9 is expressed with the most retarded phase being “0” and by the use of an advance amount of the valve timing from the most retarded phase. In addition, in the following description, the valve timing of the intake valve 9 will be referred to as an intake valve timing.

A deposit derived from unburned fuel, blow-by gas, lubricating oil, or the like gradually adheres inside the combustion chamber 2 of the internal combustion engine 1. When the amount of the deposit adhesion increases, the knocking might become more and more likely to occur due to, for example, a decrease in a substantial volume of the combustion chamber 2 that leads to an increase in an in-cylinder pressure during the combustion.

In addition, the internal EGR amount, the actual compression ratio of the internal combustion engine 1, a flow of an air flow in the cylinder, or the like changes when the intake valve timing changes. Accordingly, the ease of the occurrence of the knocking that is attributable to the deposit adhesion changes, even at the same deposit adhesion amount, when the intake valve timing varies.

In this embodiment, an ignition timing correction is performed in view of the deposit adhesion amount and the intake valve timing. Hereinafter, an ignition timing control for the internal combustion engine 1 that is carried out by the electronic control unit 26 will be described.

As illustrated in FIG. 3, the electronic control unit 26 calculates a final ignition timing afin based on the following Equation (1) and sets the calculated final ignition timing gin as an actual ignition timing. This final ignition timing afin is a value that is calculated such that the ignition timing is on the advance side to the maximum extent possible while the occurrence of the knocking is suppressed.

afin=akmf+agknk−akcs (1)

afin: Final ignition timing

akmf: Most retarded ignition timing

agknk: Knocking learning value

akcs: Feedback correction value

The feedback correction value akcs in Equation (1) is a value for the final ignition timing afin to be promptly corrected depending on the presence or absence of the occurrence of the knocking. A value of the feedback correction value akcs is set depending on a situation of the occurrence of the knocking that is detected by the knock sensor 36. Specifically, the value of the feedback correction value akcs is gradually decreased when it is determined that a detected level of the knocking falls short of a predetermined determination value and is equal to or lower than a level at which the knocking can be sufficiently allowed. When the detected level of the knocking is equal to or higher than the determination value, the value of the feedback correction value akcs is increased by a predetermined value. In a case where the feedback correction value akcs has a negative value, the final ignition timing afin obtained from the above-described Equation (1) is corrected to a timing on the advance side by the feedback correction value akcs. The final ignition timing afin, obtained from the above-described Equation (1), is corrected to a timing on the retard side by the feedback correction value akcs, when the feedback correction value akcs has a positive value.

The knocking learning value agknk in Equation (1) is a value that is updated once an absolute value of the feedback correction value akcs increases to some extent and is a value for suppressing an excessive increase in the absolute value of the feedback correction value akcs. In other words, the knocking learning value agknk is updated to gradually shrink the absolute value of the feedback correction value akcs when a state where the absolute value of the feedback correction value akcs exceeds a predetermined value A (|akcs|>A) continues for at least a predetermined period of time.

More specifically, a predetermined value B, which is a positive value, is subtracted from a value of the knocking learning value agknk and the same predetermined value B is subtracted from the value of the feedback correction value akcs as well when a state where the feedback correction value akcs is a positive value and the absolute value exceeds the predetermined value A (akcs>A) continues. This causes the absolute value of the feedback correction value akcs subsequent to the subtraction to become a value equal to or less than the predetermined value A. In addition, both the knocking learning value agknk and the feedback correction value akcs are updated with the same value (predetermined value B). Accordingly, despite the subtraction of the predetermined value B from the feedback correction value akcs, a value of the final ignition timing afin is maintained at the same value without changing from the value before the subtraction. When a state where the feedback correction value akcs is a negative value and the absolute value exceeds the predetermined value A (akcs<A) continues, the predetermined value B described above is added to each of the value of the knocking learning value agknk and the value of the feedback correction value akcs. This causes the absolute value of the feedback correction value akcs subsequent to the addition to become a value equal to or less than the predetermined value A. Both the knocking learning value agknk and the feedback correction value akcs are updated with the same value (predetermined value B). Accordingly, despite the addition of the predetermined value B to the feedback correction value akcs, the value of the final ignition timing afin is maintained at the same value without changing from the value before the addition. The value of the knocking learning value agknk updated in this manner is stored in the backup memory of the electronic control unit 26, and the value is retained even when the engine remains stopped.

A value of the most retarded ignition timing akmf in Equation (1) is set as the most retarded timing of the ignition timing at which the knocking can be within the sufficiently allowable level even under the worst condition that is assumed. Specifically, a value that is retarded by a deposit correction amount adepvt and a constant RTD determined in advance with respect to a knock limit ignition timing aknok is set as the most retarded ignition timing akmf as represented by the following Equation (2).

akmf=aknok−adepvt−RTD (2)

The knock limit ignition timing aknok in Equation (2) is an advance limit timing of the ignition timing at which the knocking can be within the allowable level under the best condition that is assumed when a low-octane fuel with a low knock limit is used. A value of the knock limit ignition timing aknok is variably set in view of, for example, the present engine rotation speed NE, the engine load, and a value of the valve timing of the intake valve 9 set by the variable valve mechanism 13.

The deposit correction amount adepvt in Equation (2) is a value indicating a retard correction amount for the ignition timing depending on a present degree of the deposit adhesion in the combustion chamber 2 and a present valve timing of the intake valve 9.

The constant RTD in Equation (2) is an ignition timing retard amount that is required for the occurrence of the knocking attributable to factors other than the deposit (such as an intake temperature, the cooling water temperature, a humidity of the intake air, a variation of the compression ratio of the air-fuel mixture, and the use of a low-octane fuel of low quality) to be reliably suppressed. An adaptive value obtained in advance by a test or the like is set as the constant RTD.

As represented by the following Equation (3), the electronic control unit 26 calculates the deposit correction amount adepvt by using a reference correction amount DLAKNOKBS, a ratio learning value rgknk, a relative correction amount DLAKNOKRE, and a correction ratio kavvt. The electronic control unit 26 that calculates the deposit correction amount adepvt constitutes the correction amount calculation unit described above.

adepvt=DLAKNOKBS×rgknk+DLAKNOKRE×rgknk×kavvt (3)

The ratio learning value rgknk in Equation (3) is a value that indicates a degree of the deposit adhesion onto the combustion chamber 2 described above. Herein, the degree of the deposit adhesion is expressed as a value of the ratio learning value rgknk with a state of no deposit adhesion at all being regarded as a ratio learning value rgknk of “0” and a state where the deposit adhesion amount is at its maximum value that is assumed being regarded as a ratio learning value rgknk of “1”.

A value of “0” is set as an initial value of the ratio learning value rgknk during its factory shipment with no deposit adhesion. The value of the ratio learning value rgknk gradually increases or decreases thereafter, depending on a frequency of the occurrence of the knocking that is detected by the knock sensor 36, within a range of “0” to “1”. Specifically, the electronic control unit 26 gradually increases the value of the ratio learning value rgknk as the frequency of the occurrence of the knocking increases and gradually decreases the value of the ratio learning value rgknk as the frequency of the occurrence of the knocking decreases. The electronic control unit 26 that sets this ratio learning value rgknk constitutes the deposit calculation unit described above.

The correction ratio kavvt in Equation (3) is a value that indicates a degree of an impact that a present intake valve timing has on the ignition timing correction depending on the deposit adhesion. As represented by the following Equation (4), the correction ratio kavvt is a value that is obtained by dividing a timing correction amount avvt by a base correction amount avvtb, that is, a value indicating a ratio of the timing correction amount avvt to the base correction amount avvtb.

kavvt=avvt/avvtb (4)

The base correction amount avvtb in Equation (4) is an ignition timing correction amount that is required when the ignition timing is corrected in accordance with a degree of an impact of the intake valve timing on the knocking. More specifically, the base correction amount avvtb is an advance correction amount for the ignition timing that is required when the intake valve timing has become an adaptation phase VTad at the current engine rotation speed NE and engine load KL, and the base correction amount avvtb is obtained based on the current engine rotation speed NE and engine load KL and with reference to a map set in advance or the like.

The adaptation phase VTad of the intake valve timing at the current engine rotation speed NE and engine load KL refers to an ideal intake valve timing in accordance with the engine operation state. In this embodiment, for example, the target valve timing VTp that is set based on the engine operation state corresponds to the adaptation phase VTad.

The timing correction amount avvt is also an ignition timing correction amount that is required when the ignition timing is corrected in accordance with the degree of the impact of the intake valve timing on the knocking. The timing correction amount avvt is an advance correction amount for the ignition timing that is calculated in a transient period when the actual valve timing VTr changes to the adaptation phase VTad. In other words, the timing correction amount avvt is an advance correction amount for the ignition timing that is required at the current actual valve timing VTr. The timing correction amount avvt is obtained based on the actual valve timing VTr, the intake pressure PM, and the like and with reference to a map set in advance or the like.

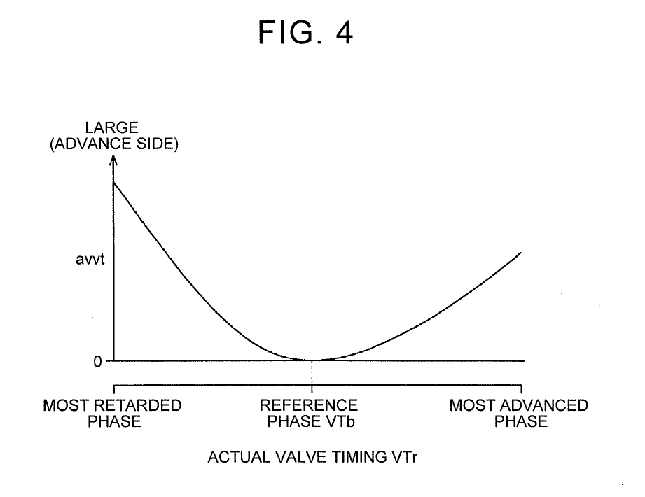

In this embodiment, a phase at a time when the actual valve timing VTr is a phase in the vicinity of the intermediate phase described above and the internal EGR amount (the amount of the exhaust gas remaining in the cylinder after the combustion of the air-fuel mixture) is at its minimum is regarded as a reference phase VTb as illustrated in FIG. 4. When the actual valve timing VTr is the reference phase VTb, the timing correction amount avvt is set to “0”.

Once the actual valve timing VTr becomes a phase on the side further advanced than the reference phase VTb, a valve overlap amount of the intake valve 9 and the exhaust valve 10 increases, and thus the internal EGR amount increases and the knocking becomes less likely to occur. Accordingly, as the actual valve timing VTr changes to the phase on the side further advanced than the reference phase VTb, the timing correction amount avvt is a value that corrects the ignition timing to the advance side and is variably set based on the actual valve timing VTr, the intake pressure PM, and the like such that its correction amount increases.

Once the actual valve timing VTr becomes a phase on the side further retarded than the reference phase VTb, the intake air suctioned into the cylinder is blown back to the intake port 3a in a first half of the compression stroke, and thus the actual compression ratio falls and the knocking becomes less likely to occur. Accordingly, even in a case where the actual valve timing VTr changes to the phase on the side further retarded than the reference phase VTb, the timing correction amount avvt is the value that corrects the ignition timing to the advance side and is variably set based on the actual valve timing VTr, the intake pressure PM, and the like such that its correction amount increases.

As described above, the timing correction amount avvt is the advance correction amount for the ignition timing that is calculated in the transient period when the actual valve timing VTr changes to the adaptation phase VTad. In a case where the adaptation phase VTad of the intake valve timing and the actual valve timing VTr correspond to each other, the timing correction amount avvt has the same value as the base correction amount avvtb.

The correction ratio kavvt that is obtained as described above is a value that indicates ratios of the ignition timing correction amount corresponding to the adaptation phase VTad of the intake valve timing depending on the current engine operation state and the ignition timing correction amount depending on the current actual valve timing VTr. The correction ratio kavvt is “0” in a case where at least one of the base correction amount avvtb and the timing correction amount avvt is “0”. The correction ratio kavvt approaches “1” as the actual valve timing VTr approaches the adaptation phase VTad of the intake valve timing at the current engine rotation speed NE and engine load KL, that is, as a deviation between the base correction amount avvtb and the timing correction amount avvt decreases. Then, the correction ratio kavvt becomes “1” when the base correction amount avvtb and the timing correction amount avvt correspond to each other by the adaptation phase VTad of the intake valve timing at the current engine rotation speed NE and engine load KL and the actual valve timing VTr corresponding to each other.

During the valve timing control for the intake valve 9, a driving control is performed on the variable valve mechanism 13 such that the target valve timing VTp and the actual valve timing VTr correspond to each other. However, the actual valve timing

VTr slightly varies in some cases to the advance side or the retard side with respect to the target valve timing VTp because of, for example, a reaction force of a valve spring that is disposed in the intake valve 9. This variation of the actual valve timing VTr causes the timing correction amount avvt to vary as well.

The number of the denominator in the above-described Equation (4), when the base correction amount avvtb is relatively small in value (for example, when the target valve timing VTp is a value in the vicinity of the reference phase VTb), is smaller than the number of the denominator in the above-described Equation (4), when the base correction amount avvtb is relatively large in value. Accordingly, even at the same amount of a change in the timing correction amount avvt that is attributable to the variation of the actual valve timing VTr, the amount of a change in the correction ratio kavvt as a result of the change in the timing correction amount avvt increases when the base correction amount avvtb is relatively small in value. In this case, the value that is obtained from “DLAKNOKRE×rgknk×kavvt” in the above-described Equation (3) significantly changes even with a slight variation of the actual valve timing VTr, and thus the deposit correction amount adepvt significantly changes as well. Accordingly, the slight variation of the actual valve timing VTr might result in a significant change in the final ignition timing afin obtained from the above-described Equation (1) and Equation (2) and affect the calculation of the final ignition timing afin.

In a case where the set base correction amount avvtb falls short of a predetermined threshold a (for example, α=1° CA), the electronic control unit 26 performs a zero setting processing for setting the correction ratio kavvt to “0”. By this zero setting processing being performed, the correction ratio kavvt is set to “0”, regardless of a value of the actual valve timing VTr, when the base correction amount avvtb falls short of the predetermined threshold a. Accordingly, a significant change in the correction ratio kavvt as a result of the variation of the actual valve timing VTr is suppressed, and thus a significant change in the deposit correction amount adepvt is also suppressed and the deposit correction amount adepvt is stabilized. Accordingly, an adverse effect that the variation of the actual valve timing VTr has on the calculation of the final ignition timing afin can be suppressed.

The reference correction amount DLAKNOKBS in the above-described Equation (3) is a first adaptive value for the retard correction amount for the ignition timing with which the occurrence of the knocking can be suppressed even in a state where the deposit adhesion amount is equal to or more than a predetermined amount, that is, the deposit adhesion amount is at its maximum amount that is assumed while the actual valve timing VTr has become the reference phase VTb. This reference correction amount DLAKNOKBS varies depending on the engine operation state. Accordingly, in this embodiment, the value of the reference correction amount DLAKNOKBS is set based on the engine rotation speed NE and the engine load KL and with reference to an adaptation map set in advance.

The relative correction amount DLAKNOKRE in the above-described Equation (3) is a value that is obtained by subtracting the reference correction amount DLAKNOKBS from an adaptive correction amount DLAKNOK. The relative correction amount DLAKNOKRE is obtained from the following Equation (5).

DLAKNOKRE=DLAKNOK−DLAKNOKBS (5)

The adaptive correction amount DLAKNOK in Equation (5) is a second adaptive value for the retard correction amount for the ignition timing with which the occurrence of the knocking can be suppressed even in a state where the deposit adhesion amount is equal to or more than the predetermined amount, that is, the deposit adhesion amount is at its maximum that is assumed in a state where the intake valve timing has become the adaptation phase VTad at the current engine rotation speed NE and engine load KL. This adaptive correction amount DLAKNOK also varies depending on the engine operation state. Accordingly, in this embodiment, a value of the adaptive correction amount DLAKNOK is set based on the engine rotation speed NE and the engine load KL and with reference to an adaptation map set in advance.

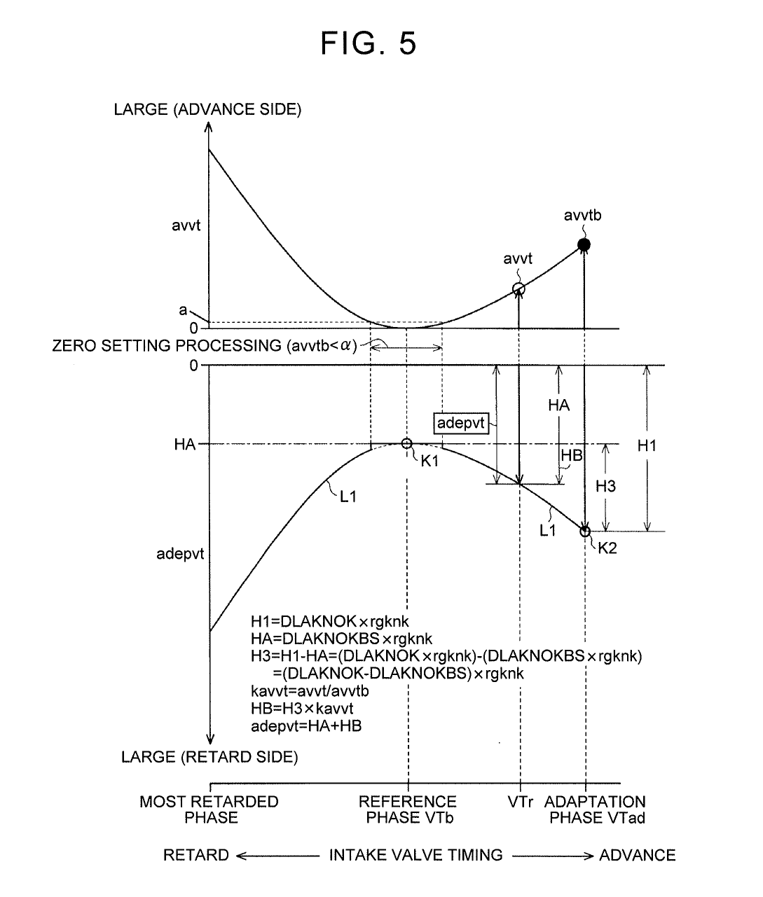

An effect that is obtained by calculating the deposit correction amount adepvt by the use of the above-described Equation (3) will be described with reference to FIG. 5. FIG. 5 shows a change in the deposit correction amount adepvt during a change in the actual valve timing VTr of the intake valve 9 toward the adaptation phase VTad in a state where the engine rotation speed NE and the engine load KL are constant.

Firstly, as illustrated in FIG. 5, a retard correction amount H1 for the ignition timing in accordance with the present degree of the deposit adhesion is obtained, in a state where the intake valve timing has become the adaptation phase VTad, by the adaptive correction amount DLAKNOK being multiplied by the ratio learning value rgknk showing the present degree of the deposit adhesion as shown in the following Equation (6).

H1=DLAKNOK×rgknk (6)

In a case where the minimum retard correction amount for the ignition timing that is required in accordance with the present degree of the deposit adhesion and without depending on the intake valve timing is regarded as a first correction amount HA, the first correction amount HA is obtained by the reference correction amount DLAKNOKBS being multiplied by the ratio learning value rgknk showing the degree of the deposit adhesion as shown in the following Equation (7).

HA=DLAKNOKBS ×rgknk (7)

Then, by the first correction amount HA being subtracted from the retard correction amount H1 as shown in the following Equation (8), a retard correction amount H3 for the ignition timing in accordance with the amount of the impact of the intake valve timing is obtained from the retard correction amounts for the ignition timing in accordance with the deposit adhesion in a state where the intake valve timing has become the adaptation phase VTad.

H3=H1−HA (8)

=(DLAKNOK×rgknk)−(DLAKNOKBS×rgknk)=(DLAKNOK−DLAKNOKBS)×rgkn

Because of the above-described Equation (5), the retard correction amount H3 can be expressed as in the following Equation (9).

H3=DLAKNOKRE×rgknk (9)

In a case where the retard correction amount for the ignition timing in accordance with the amount of the impact of the present intake valve timing among the retard correction amounts for the ignition timing in accordance with the degree of the deposit adhesion is regarded as a second correction amount HB, the second correction amount HB can be obtained by the retard correction amount H3 in the adaptation phase VTad being multiplied by the correction ratio kavvt as shown in the following Equation (10).

HB=H3×kavvt (10)

The deposit correction amount adepvt, which is the retard correction amount for the ignition timing in accordance with the present degree of the deposit adhesion in the combustion chamber 2 and the present valve timing of the intake valve 9, is obtained by the following Equation (11).

adepvt=HA+HB (11)

In other words, the deposit correction amount adepvt is obtained by a sum of the first correction amount HA that is the minimum correction amount which is required in accordance with the present degree of the deposit adhesion and without depending on the intake valve timing and the second correction amount HB in accordance with the amount of the impact of the present intake valve timing among the retard correction amounts for the ignition timing in accordance with the degree of the deposit adhesion being obtained.

Because of Equation (7), Equation (9), and Equation (10), Equation (11) is an equation equivalent to “adepvt=DLAKNOKBS×rgknk+DLAKNOKRE×rgknk×kavvt” and corresponding to the above-described Equation (3).

The deposit correction amount adepvt that is calculated by the above-described Equation (3) as described above is calculated as the sum of the first correction amount HA and the second correction amount HB. An optimum value for the retard correction amount for the ignition timing at a time when the valve timing has little effect is calculated when the valve timing has become the reference phase VTb at the retard correction amount for the ignition timing in accordance with the present degree of the deposit adhesion by the first correction amount HA being calculated, that is, during the calculation of the retard correction amount for the ignition timing in accordance with the degree of the deposit adhesion by the valve timing at which the internal EGR amount in the combustion chamber 2 is minimized being set.

As shown in the above-described Equation (5), the relative correction amount DLAKNOKRE is a value that is obtained by subtracting the reference correction amount DLAKNOKBS from the adaptive correction amount DLAKNOK and is a value that is obtained by subtracting the adaptive value for the retard correction amount in the reference phase VTb from the adaptive value for the retard correction amount in the adaptation phase VTad. Accordingly, the relative correction amount DLAKNOKRE also becomes an adaptive value for the retard correction amount in the adaptation phase VTad.

As shown in the above-described Equation (9) and Equation (10), the second correction amount HB, which is the relative correction amount DLAKNOKRE that is an adaptive value corrected with the correction ratio kavvt and the ratio learning value rgknk, is a value that is obtained by the use of an adaptive value and is an optimum value reflecting the amount of the impact of the present valve timing among the retard correction amounts for the ignition timing in accordance with the present valve timing and the present degree of the deposit adhesion.

As shown in the above-described Equation (11), the sum of the first correction amount HA that is obtained by the use of the reference correction amount DLAKNOKBS, which is an adaptive value, and the second correction amount HB that is obtained by the use of the relative correction amount DLAKNOKRE, which is an adaptive value, the correction ratio kavvt, or the like is set as the deposit correction amount adepvt.

Accordingly, this deposit correction amount adepvt is a value that is obtained by the use of an adaptive value in the reference phase VTb and an adaptive value in the adaptation phase VTad. In other words, as illustrated in FIG. 5, the deposit correction amount adepvt is a value obtained when a retard correction amount present on a line L1, which connects the optimum value of the retard correction amount in the reference phase VTb (the first correction amount HA obtained from the above-described Equation (7): round point K1 in FIG. 5) and the optimum value of the retard correction amount in the adaptation phase VTad (the retard correction amount H1 obtained from the above-described Equation (6): round point K2 in FIG. 5) to each other, is interpolated. Accordingly, the deposit correction amount adepvt is a value that is close to the retard correction amount which is actually required for the suppression of the occurrence of the knocking. Accordingly, in this embodiment, the deposit correction amount adepvt, which is the retard correction amount for the ignition timing that is in accordance with the present degree of the deposit adhesion in the combustion chamber 2 and the present intake valve timing, is accurately calculated. Hence, the occurrence of the knocking that is attributable to the deposit adhesion can be appropriately suppressed.

In a case where the base correction amount avvtb falls short of the predetermined threshold a, the zero setting processing described above is performed, and thus the correction ratio kavvt is set to “0”. Accordingly, in a case where this zero setting processing is performed, the second correction amount HB that is calculated from the above-described Equation (10) is “0”. However, the sum of the first correction amount HA and the second correction amount HB constitutes the deposit correction amount adepvt even in this case, and thus at least the first correction amount HA, that is, the minimum retard correction amount that is required due to the deposit adhesion, is set to the deposit correction amount adepvt. Hence, the ignition timing is retard-corrected by at least the first correction amount HA compared to a case where the deposit correction amount adepvt is provisionally set to “0” during the execution of the zero setting processing. Accordingly, the occurrence of the knocking during the execution of the zero setting processing can be more appropriately suppressed.

The following effects can be achieved by this embodiment described above.

(1) The occurrence of the knocking that is attributable to the deposit adhesion can be appropriately suppressed by the deposit correction amount adepvt being set as the sum of the first correction amount HA and the second correction amount HB. In addition, the deposit correction amount adepvt can be accurately calculated, and thus an engine output decline attributable to an excessive retard correction of the ignition timing can be suppressed as well.

(2) Since the sum of the first correction amount HA and the second correction amount HB constitutes the deposit correction amount adepvt, the ignition timing is retard-corrected by at least the first correction amount HA even when the zero setting processing described above is executed. Accordingly, the occurrence of the knocking during the execution of the zero setting processing can be more appropriately suppressed.

The above-described embodiment can also be carried out after being modified as follows. In the above-described embodiment, the reference correction amount DLAKNOKBS, the adaptive correction amount DLAKNOK, the base correction amount avvtb, and the timing correction amount avvt are obtained from the maps. Instead, however, each of these correction amounts may also be obtained by the use of a functional formula.

The zero setting processing does not necessarily have to be executed, and the execution of the same processing may be omitted. The variable valve mechanism 13 is an electric variable valve mechanism in the embodiment described above, but the variable valve mechanism 13 may be a hydraulic variable valve mechanism as well.

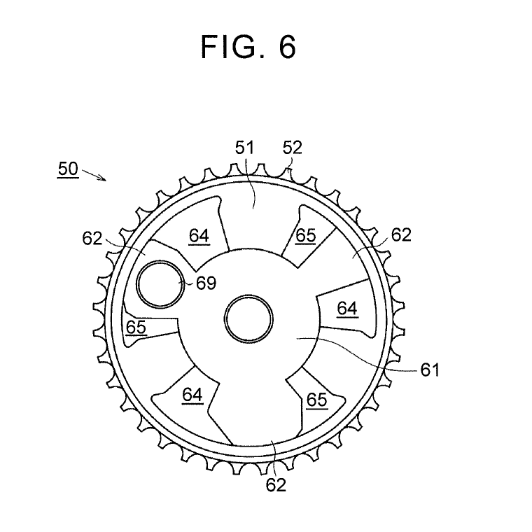

A basic structure of a hydraulic variable valve mechanism 50 is illustrated in FIG. 6. This hydraulic variable valve mechanism 50 is provided with a housing 51 and an internal rotor 61. Retard hydraulic chambers 64 and advance hydraulic chambers 65 are provided in an inner portion of the housing 51, and the internal rotor 61 is disposed in the housing 51. A sprocket 52 is disposed on an outer periphery of the housing 51, and a timing chain that rotates with the crankshaft of the internal combustion engine is wound around the sprocket 52. A hydraulic pressure is supplied to the retard hydraulic chambers 64 and the advance hydraulic chambers 65 through an appropriate hydraulic circuit. An intake camshaft is fixed to the center of rotation of the internal rotor 61. In addition, vanes 62 that partition the retard hydraulic chambers 64 and the advance hydraulic chambers 65 from each other are disposed in the internal rotor 61. In this hydraulic variable valve mechanism 50, a relative rotational phase of the intake camshaft with respect to the crankshaft is changed by the housing 51 and the internal rotor 61 relatively rotating by the hydraulic pressure supplied to the retard hydraulic chambers 64 and the advance hydraulic chambers 65 being controlled, and this causes the valve timing of the intake valve to change. In addition, a lock pin 69 is disposed in the vane 62 so that the valve timing of the intake valve is held in the intermediate phase set in the middle between the most retarded phase and the most advanced phase, and the valve timing of the intake valve is fixed in the intermediate phase by this lock pin 69 being engaged with a hole formed in the housing 51.

In this hydraulic variable valve mechanism 50, an operation of the lock pin 69 allows the valve timing of the intake valve 9 during the start of the internal combustion engine 1 to be held in the intermediate phase set in the middle between the most retarded phase and the most advanced phase as in the electric variable valve mechanism.

What is claimed is:

1. A control device for an internal combustion engine, the internal combustion engine including an intake valve, a combustion chamber, and a variable valve mechanism, the variable valve mechanism being configured to change a valve timing of the intake valve, and the variable valve mechanism being configured to hold the valve timing in an intermediate phase when the internal combustion engine is started, the intermediate phase being a phase set in a middle between a most retarded phase and a most advanced phase of the valve timing of the intake valve, the control device comprising
an electronic control unit configured to:
calculate a degree of deposit adhesion in the combustion chamber;
calculate a deposit correction amount, the deposit correction amount being a retard correction amount for an ignition timing set in accordance with the degree of the deposit adhesion;
calculate, as a reference correction amount, a first adaptive value for the retard correction amount for the ignition timing with which occurrence of knocking is suppressed when the amount of the deposit adhesion is equal to or more than a predetermined amount and a phase of a present valve timing is a reference phase, the reference phase being a phase of the valve timing at which an internal exhaust gas recirculation amount in the combustion chamber is minimized;
calculate a first correction amount by correcting the reference correction amount in accordance with the degree of the deposit adhesion;
calculate, as an adaptive correction amount, a second adaptive value for the retard correction amount for the ignition timing with which the occurrence of the knocking is suppressed when the amount of the deposit adhesion is equal to or more than the predetermined amount and the phase of the present valve timing is an adaptation phase, the adaptation phase being a phase of the valve timing optimal in accordance with an engine operation state;
calculate a relative correction amount by subtracting the reference correction amount from the adaptive correction amount;
calculate a correction ratio indicating a degree of an effect of the present valve timing on an ignition timing correction in accordance with the degree of the deposit adhesion;
calculate a second correction amount by correcting the relative correction amount in accordance with the degree of the deposit adhesion and the correction ratio; and
set a sum of the first correction amount and the second correction amount as the deposit correction amount.

2. The control device according to claim 1,
wherein the electronic control unit is configured to calculate a base correction amount and a timing correction amount,
the electronic control unit is configured to calculate in accordance with a degree of an effect of the valve timing on the knocking of the internal combustion engine,
the base correction amount is a correction amount of an ignition timing when the valve timing is the adaptation phase,
the electronic control unit is configured to calculate the timing correction amount in accordance with the degree of the effect of the valve timing on the knocking,
the timing correction amount is a correction amount of the ignition timing and the timing correction amount is set in accordance with the present valve timing, and
the electronic control unit is configured to set a ratio of the timing correction amount to the base correction amount as the correction ratio.

3. The control device according to claim 2,
wherein the electronic control unit is configured to set the correction ratio to 0 when the base correction amount is equal to or less than a predetermined threshold.

4. The control device according to claim 1,
wherein the variable valve mechanism is an electric mechanism driven by an electric motor.

5. The control device according to claim 1,
wherein the variable valve mechanism is a hydraulic mechanism, and
the variable valve mechanism includes a lock pin fixing the valve timing in the intermediate phase.

6. A control method for an internal combustion engine, the internal combustion engine including an intake valve, a combustion chamber, and a variable valve mechanism, the variable valve mechanism being configured to change a valve timing of the intake valve, and the variable valve mechanism being configured to hold the valve timing in an intermediate phase when the internal combustion engine is started, the intermediate phase being a phase set in a middle between a most retarded phase and a most advanced phase of the valve timing of the intake valve, the internal combustion engine is provided with an electronic control unit, the control method comprising:
calculating, by the electronic control unit, a degree of deposit adhesion in the combustion chamber;
calculating, by the electronic control unit, a deposit correction amount, the deposit correction amount being a retard correction amount for an ignition timing set in accordance with the degree of the deposit adhesion;
calculating, by the electronic control unit, as a reference correction amount, a first adaptive value for the retard correction amount for the ignition timing with which occurrence of knocking is suppressed when the amount of the deposit adhesion is equal to or more than a predetermined amount and a phase of the present valve timing is a reference phase, the reference phase being a phase of the valve timing at which an internal exhaust gas recirculation amount in the combustion chamber is minimized;
calculating, by the electronic control unit, a first correction amount by correcting the reference correction amount in accordance with the degree of the deposit adhesion;
calculating, by the electronic control unit, as an adaptive correction amount, a second adaptive value for the retard correction amount for the ignition timing with which the occurrence of the knocking is suppressed when the amount of the deposit adhesion is equal to or more than the predetermined amount and the phase of a present valve timing is an adaptation phase, the adaptation phase being a phase of the valve timing optimal in accordance with an engine operation state;
calculating, by the electronic control unit, a relative correction amount by subtracting the reference correction amount from the adaptive correction amount;
calculating, by the electronic control unit, a correction ratio indicating a degree of an effect of the present valve timing on an ignition timing correction in accordance with the degree of the deposit adhesion;
calculating, by the electronic control unit, a second correction amount by correcting the relative correction amount in accordance with the degree of the deposit adhesion and the correction ratio; and
setting, by the electronic control unit, a sum of the first correction amount and the second correction amount as the deposit correction amount.
